(19) United States
(12) Patent Application Publication
(10) Pub. No.: US 2023/0394970 A1
(43) Pub. Date: Dec. 7, 2023

(54) EVALUATION SYSTEM, EVALUATION METHOD, AND EVALUATION PROGRAM

(71) Applicant: NEC Corporation, Minato-ku, Tokyo (JP)

(72) Inventor: Ryota HIGA, Tokyo (JP)

(73) Assignee: NEC Corporation, Minato-ku, Tokyo (JP)

(21) Appl. No.: 18/032,873

(22) PCT Filed: Oct. 28, 2020
(86) PCT No.: PCT/JP2020/040484

§ 371 Date: Apr. 20, 2023

(51) Int. Cl. G08G 1/16

(52) U.S. Cl. CPC G08G 1/16

(57) ABSTRACT

A learning means 81 learns a plan evaluation function that evaluates an internal value in an own agent when a mission including an action is planned so as to maximize a value of a mission evaluation function that calculates a value of the action of the own agent in a certain state or an expected value of a cumulative sum of the values. An evaluation means 82 evaluates, using a utility function that defines a difference between the internal values calculated using the plan evaluation function, a utility of the mission when a target resource, which is a resource to be a target candidate for negotiation, is transferred to another agent or when the target resource is transferred from the other agent.

### TECHNICAL FIELD

The present invention relates to an evaluation system, an evaluation method, and an evaluation program configured to evaluate a plan made by an own agent.

### BACKGROUND ART

In recent years, the importance of automatic negotiation has further increased. For example, in a scene where an unmanned aircraft vehicle (UAV) such as a drone is used, the technology of automatic negotiation is effective as a mechanism configured to secure or provide an operation route and an operation area for the UAV to fly safely.

For example, in a case where there is an interaction with another agent with respect to an area used for operation, it is important to negotiate with another agent to make a selection that is not disadvantageous for oneself even in a case where it is necessary to share and take over the area to be used for movement with another agent.

PTL 1 describes an area evaluation system configured to evaluate an area to be used for operation of a moving body. In the area evaluation system described in PTL 1, when a first mission using a first area and a second mission not using the first area are given, the utility of the first area is evaluated based on a difference between the utility of the first mission and the utility of the second mission.

It is noted that NPL 1 describes alternating offers protocol (AOP) which are an example of a protocol configured to perform automatic negotiation.

### CITATION LIST

### Patent Literature

PTL 1: WO 2019/167161 A

### Non Patent Literature

NPL 1: Reyhan A, et al., “Alternating Offers Protocols for Multilateral Negotiation”, Modem Approaches to Agent-based Complex Automated Negotiation, pp.153-167, April 2017.

### SUMMARY OF INVENTION

### Technical Problem

As described above, for example, a consideration is given as to a scene where an application for an operation plan is made to an operation management system configured to perform exclusive control of an area with another agent, or a scene where the right to use an area is transferred by negotiation with another agent. In such a scene, it is necessary to appropriately evaluate a mission content, an operation route of each moving body included in the mission content, and an area to be used in the operation route, and then select the mission content so as not to be disadvantageous to oneself.

In addition, as a result of evaluating a certain area to be used in the planned mission content, if it is disadvantageous for oneself to use the area, it is required to return to the mission plan to determine a more appropriate mission, that is, to re-plan the mission.

As described above, in a case where there is an interaction with another agent, it is necessary to perform evaluation in consideration of the utility at a mission level, more specifically, all the tasks included in the mission and the utility based on the tasks in order not to make a selection disadvantageous to oneself.

In the present invention, a mission is defined as “execution of one or more tasks (duties) managed by an agent (specific plan group)”. For example, in the case of the operation plan described above, the mission can be defined as “an operation plan group obtained by allocating resources (moving body resources, area resources, and the like) so as to be able to execute each of one or more tasks managed by an agent”.

In addition, in the operation plan described above, the task can be defined as a task involving the operation of the moving body and including at least designation of space and time. It is noted that an operation plan group obtained by allocating moving body resources to a certain task and determining an operation route for each of the allocated moving body resources is an example of a mission.

By using the area evaluation system described in PTL 1, for example, even in a case where there is an interaction with another agent with respect to an area to be used for operation, it is possible to appropriately evaluate an area for the own agent.

On the other hand, in the area evaluation system described in PTL 1, the utility of a mission is evaluated based on a predetermined function using rewards and costs of the mission as arguments. However, it is considered that the utility of the mission varies depending on contents planned by each agent. Therefore, it is preferable not only to evaluate the mission based on the existing reward function, but also to perform unique evaluation reflecting a plan or the like inside each agent.

Therefore, an object of the present invention is to provide an evaluation system, an evaluation method, and an evaluation program capable of appropriately evaluating a utility for an own agent even in a case where there is an interaction with another agent regarding a mission to be planned.

### Solution to Problem

An evaluation system according to the present invention includes: a learning means configured to learn a plan evaluation function that evaluates an internal value in an own agent when a mission including an action is planned so as to maximize a value of a mission evaluation function that calculates a value of the action of the own agent in a certain state or an expected value of a cumulative sum of the values; and an evaluation means configured to evaluate, using a utility function that defines a difference between the internal values calculated using the plan evaluation function, a utility of the mission when a target resource, which is a resource to be a target candidate for negotiation, is transferred to another agent or when the target resource is transferred from the other agent.

An evaluation method according to the present invention includes: learning, by a computer, a plan evaluation function that evaluates an internal value in an own agent when a mission including an action is planned so as to maximize a value of a mission evaluation function that calculates a value of the action of the own agent in a certain state or an expected value of a cumulative sum of the values; and evaluating, by the computer using a utility function that defines a difference between the internal values calculated using the plan evaluation function, a utility of the mission when a target resource, which is a resource to be a target candidate for negotiation, is transferred to another agent or when the target resource is transferred from the other agent.

An evaluation program according to the present invention causes a computer to execute a learning process of learning a plan evaluation function that evaluates an internal value in an own agent when a mission including an action is planned so as to maximize a value of a mission evaluation function that calculates a value of the action of the own agent in a certain state or an expected value of a cumulative sum of the values, and an evaluation process of evaluating, using a utility function that defines a difference between the internal values calculated using the plan evaluation function, a utility of the mission when a target resource, which is a resource to be a target candidate for negotiation, is transferred to another agent or when the target resource is transferred from the other agent.

Advantageous Effects of Invention

According to the present invention, even in a case where there is an interaction with another agent regarding a mission to be planned, a utility for an own agent can be appropriately evaluated.

### BRIEF DESCRIPTION OF DRAWINGS

FIG. 1 It depicts a block diagram illustrating a configuration example of an exemplary embodiment of a negotiation system according to the present invention.

FIG. 2 It depicts a flowchart illustrating an operation example of a planning unit.

FIG. 3 It depicts a flowchart illustrating an operation example of the negotiation system.

FIG. 4 It depicts a flowchart illustrating another operation example of the negotiation system.

FIG. 5 It depicts a block diagram illustrating an outline of an evaluation system according to the present invention.

FIG. 6 It depicts a schematic block diagram illustrating a configuration of a computer according to at least one exemplary embodiment.

### DESCRIPTION OF EMBODIMENTS

Hereinafter, exemplary embodiments of the present invention will be described with reference to the drawings.

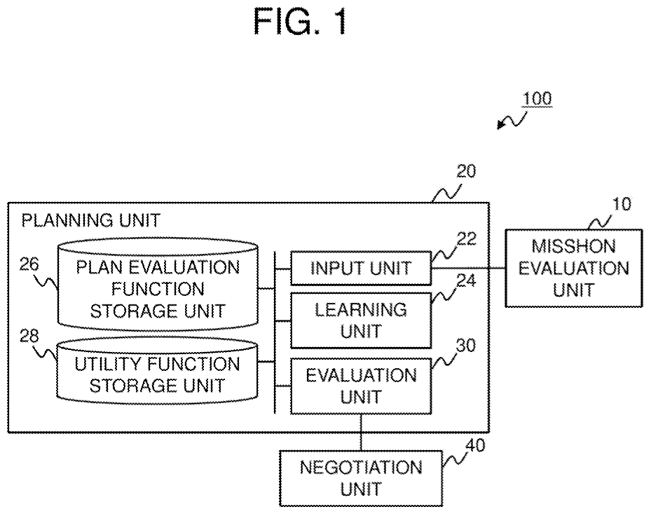

FIG. 1 is a block diagram illustrating a configuration example of an exemplary embodiment of a negotiation system according to the present invention. A negotiation system 100 according to the present exemplary embodiment includes a mission evaluation unit 10, a planning unit 20, and a negotiation unit 40.

The mission evaluation unit 10 inputs, to the planning unit 20, a function (hereinafter, referred to as a mission evaluation function) that evaluates a mission in terms of an economic or business value (hereinafter, the same may be referred to as a reward). The mission evaluation function is a function that calculates a value (that is, the reward) of an action a of the own agent (for the mission) in a certain state s. This action is a result of decision-making (policy) of the own agent, and can be referred to as a result based on a policy function in the case of reinforcement learning. In other words, the mission evaluation function is a function that derives a reward obtained when the action a is taken in the certain state s and the process proceeds to the next aspect s′.

More specifically, the mission evaluation function corresponds to an objective function of mathematical optimization (operations research (OR)), and corresponds to a reward function when used in reinforcement learning. The mission evaluation function of the present exemplary embodiment is set in advance by an operator or the like specialized in the industry. A mode of the mission evaluation function is freely selected. For example, in the case of the operation plan described above, a mission evaluation function f may be defined as f=r−c using a cost c of a route and a reward r of a task.

Furthermore, the mission evaluation function may include a consideration for an action as a term used for calculation of a value. For example, in a situation where the negotiation is repeatedly performed, in a case where a consideration for an action can be obtained from another agent, the consideration can be fed back to a value function by including the term of the consideration in the mission evaluation function.

It can be said that this corresponds to a function of updating the value function assuming the own agent by including a part of information of another agent. Therefore, it is also possible to support so-called multi-agent reinforcement learning in which reinforcement learning is performed by reflecting information of the other party in environment information.

The planning unit 20 is a device configured to independently make a plan for each agent. The planning unit 20 includes an input unit 22, a learning unit 24, a plan evaluation function storage unit 26, a utility function storage unit 28, and an evaluation unit 30.

The input unit 22 receives an input of a reward function. It is noted that the input unit 22 may receive an input of a plan evaluation function to be described later and store the input in the plan evaluation function storage unit 26. Furthermore, for example, the input unit 22 may receive an input of information on a reward by negotiation from an operator or another device.

The learning unit 24 learns a function (hereinafter, referred to as a plan evaluation function) that evaluates an internal value in the own agent in a case where a mission including an action is planned. The learning unit 24 of the present exemplary embodiment learns the plan evaluation function so as to maximize a value of the input mission evaluation function or an expected value over the future of the cumulative sum of the values.

The learning unit 24 may learn the plan evaluation function by any machine learning. Specifically, the learning unit 24 may generate the plan evaluation function by performing reinforcement learning using a Markov decision process (MDP) mathematically modeled in time series after clearly separating the state s and the action a.

For example, the learning unit 24 may generate a policy function π(aₜ|sₜ) and a state value function V(sₜ) as plan evaluation functions by reinforcement learning using the mission evaluation function as a reward function. An example of a state sₜ includes information indicating the position of a moving body on the map at a certain time t, the weather, the wind direction, the costs of a mission, and the like. That is, the state sₜ may include not only information that directly depends on negotiation, such as position information at a certain time, but also information that does not directly depend on negotiation, such as weather and costs of a mission. In addition, as an example of an action aₜ, there is information indicating in which direction a moving body moves at a certain time t.

Furthermore, the learning unit 24 may generate a state action value function Q(sₜ, aₜ) as a plan evaluation function by reinforcement learning using the mission evaluation function as a reward function, and generate a policy function π(a|s) and a state value function V(s) using the generated state action value function Q(sₜ, aₜ).

Hereinafter, a description will be given as to an example of a method of generating the policy function π(a|s) and the state value function V(s) based on the state action value function Q(sₜ, aₜ). For example, when 0≤ε≤1, a policy function for generating an action can be defined as Equation 1 exemplified below.

$$\begin{matrix}[ Math . 1 ] & \\ π ( a \vert s ) = \{ \begin{matrix}1 - ε + \frac{ε}{\vert 𝒜 \vert} & ( a = {arg max}_{a} Q ( s , a ) ) \\ \frac{ε}{\vert 𝒜 \vert} & ( a \neq {arg max}_{a} Q ( s , a ) )\end{matrix} & ( Equation 1 )\end{matrix}$$

In addition, for example, when β≥0, the policy function can also be defined as Equation 2 exemplified below.

$$\begin{matrix}[ Math . 2 ] & \\ π ( a \vert s ) = \frac{exp ( β Q ( s , a ) )}{{\sum }_{a} exp ( β Q ( s , a ) )} & ( Equation 2 )\end{matrix}$$

In addition, by using the policy function described above, the value function can be defined as Equation 3 exemplified below.

[Math. 3]

V(s)=Σₐπ(a|s)Q(s,a) (Equation 3)

Further, the cumulative sum (that is, the total sum of rewards) G over the entire time can be defined as Equation 4 exemplified below. It is noted that the value function (Q(s, a), V(s)) is obtained by calculating the expected value of Equation 4 using the time series model in the MDP.

$$\begin{matrix}[ Math . 4 ] & \\ G = {\sum }_{t = 1}^{T} r ( {s}_{t - 1} , {a}_{t - 1} ) & ( Equation 4 )\end{matrix}$$

It is noted that the method of defining the policy function π(a|s) and the state value function V(s) is not limited to the above-described method. For example, the policy function and the state value function may be replaced with a neural network using function approximation. In addition, the policy function and the state value function may be defined using a Q function. That is, the learning unit 24 may learn the Q function, and the policy function and the state value function may be defined using the learned Q function.

Furthermore, the learning unit 24 may learn the plan evaluation function using a state transition model, which is a function representing time evolution. The state transition model can be expressed by, for example, Equation 5 exemplified below. It is noted that the learning unit 24 may learn the plan evaluation function using a simulator or a function representing a predetermined state transition in addition to the state transition model.

p(sₜ₊₁|sₜ,aₜ) (Equation 5)

By learning the plan evaluation function using the state transition model, it is possible to simultaneously evaluate not only a temporary value but also a value reflecting a prediction as a whole. For example, in the case of the operation plan described above, in addition to a value of a certain point, it is possible to generate a value and a route known from the route information at the same time. That is, since decision making based on a sequential prediction is a feature of the MDP, route negotiation can be optimized by reflecting a long-term prediction on the actual problem. It is noted that the state transition model may be generated by machine learning, and an external simulator, a given function, a database, or the like may be used as the state transition model. For example, in the case of making an operation plan, a function as a simulator may be realized by referring to information from an external engine.

Furthermore, the learning unit 24 may perform learning by reflecting a result of negotiation by the negotiation unit 40 to be described later. For example, the learning unit 24 may define the sum of a mission evaluation function and a reward by negotiation as a reward function again and perform learning using the defined reward function. For example, information input to the input unit 22 may be used as the reward by negotiation. Accordingly, it is possible to generate a model in which the route plan and the reward obtained by negotiation, which have been independently considered so far, are associated with each other.

For example, in the case of repeating similar operations, it is considered that knowing the likelihood of negotiation in advance is effective information for each agent. Therefore, for example, in a case where the other party is an operator (person), it is also possible to efficiently advance a transaction with a company that is well adjusted by reflecting the result of negotiation in the model.

In this manner, the learning unit 24 calculates a plan evaluation function that maximizes an internal plan of each agent using the mission evaluation function as a reward. Then, the learning unit 24 stores, in the plan evaluation function storage unit 26, the generated plan evaluation function (more specifically, value functions such as Q and V, policy function, state transition function, and the like).

The plan evaluation function storage unit 26 stores at least one of the plan evaluation function generated as a result of machine learning by the learning unit 24 and the plan evaluation function received by the input unit 22. The plan evaluation function storage unit 26 is realized by, for example, a magnetic disk or the like.

The utility function storage unit 28 stores a function (hereinafter, referred to as a utility function) that defines a utility of a mission using the plan evaluation function. For example, in a case where the state of the agent at the time t is defined as sₜ, the utility function may be defined as U=V(sₜ).

In the present exemplary embodiment, in particular, the utility function indicating a utility of a mission in a case where a resource (hereinafter, referred to as a target resource) ω, which is a negotiation target candidate, is transferred to another agent or a case where the target resource is transferred from another agent is defined by a difference between the internal values calculated using the plan evaluation function.

As described above, the target resource is a resource to be negotiated and is a resource (for example, time, space, and the like) to be exclusively used with another agent. In a case where the state and the consideration at the time t are respectively defined as sₜ and rₜ, the target resource ω can be defined as ω:=(sₜ, rₜ). The state sₜ includes, for example, position information of a moving body at a certain time t.

In addition, an internal value V(s) in a case where there is no negotiation with another agent is referred to as an original internal value. At this time, assuming that the original internal value V(s) is a baseline, the utility function U(ω) can be defined as Equation 6 exemplified below.

U(sₜ,rₜ):=V(sₜ)−V(s)+rₜ (Equation 6)

Equation 6 described above can be said to be an equation in which a payment (ω) is added to a difference between the internal value V(s) adjusted by negotiation and the original internal value. In addition, the utility function U may be defined as Equation 7 exemplified below so that the utility can be handled by the internal value ratio.

ln V(sₜ)−ln V(s)+ln(rₜ)=ln(V(sₜ)rₜ/V(s)) (Equation 7)

The evaluation unit 30 acquires the utility function from the utility function storage unit 28, and evaluates a utility of a mission using the acquired utility function. Specifically, the evaluation unit 30 uses a utility function to evaluate the utility of the mission when a target resource is transferred to another agent or when the target resource is transferred from another agent, and obtains the utility thereof. For example, the evaluation unit 30 may evaluate the utility by using a utility function in which the state value function as shown in the above Equation 3 is used as a plan evaluation function.

It is noted that, as described above, as a situation in which the evaluation unit 30 performs evaluation, there are two conceivable cases including, for example, a case in which a target resource is transferred to another agent and a case in which the target resource is transferred from another agent. Which one of the situations is determined may be determined, for example, according to an instruction of the negotiation unit 40 to be described later.

Specifically, when the target resource is transferred to another agent, from the point of view of the own agent, this situation corresponds to a situation in which the target resource requested from another agent is not used. Therefore, the evaluation unit 30 calculates, using the plan evaluation function, the internal value of the mission in a case where the target resource requested from another agent is not used. Here, since the use of the target resource is limited, the calculated internal value is assumed to be calculated to be lower than the original internal value. Then, the evaluation unit 30 evaluates, using the utility function, the utility in a case where the target resource is transferred to another agent.

On the other hand, when the target resource is transferred from another agent, from the point of view of the own agent, this situation corresponds to a situation in which the target resource requested by the own agent can be used. Therefore, the evaluation unit 30 calculates, using the plan evaluation function, the internal value of the mission when the target resource requested by the own agent is used. Here, the calculated internal value is assumed to be calculated to be higher than the original internal value because the available target resources increase. Then, the evaluation unit 30 evaluates, using the utility function, the utility in a case where the target resource is transferred from another agent.

It is noted that, in a case where the evaluation unit 30 stores a database (not illustrated) that accumulates past actual data and simulation data, a utility value may be calculated by inquiring data such as (sₜ, aₜ, rₜ, πₜ, Vₜ) to the database to acquire information.

It is noted that, as described above, since the planning unit 20 of the present exemplary embodiment evaluates the utility for the own agent, the planning unit 20 can be referred to as an evaluation system.

The input unit 22, the learning unit 24, and the evaluation unit 30 are implemented by a processor (for example, a central processing unit (CPU) or a graphics processing unit (GPU)) of a computer that operates according to a program (evaluation program).

For example, the program may be stored in a storage unit (not illustrated) of the planning unit 20, and the processor may read the program and operate as the input unit 22, the learning unit 24, and the evaluation unit 30 according to the program. Furthermore, the function of the planning unit 20 may be provided in a software as a service (SaaS) format.

Furthermore, each of the input unit 22, the learning unit 24, and the evaluation unit 30 may be implemented by dedicated hardware. In addition, some or all of the components of each device may be implemented by general-purpose or dedicated circuitry, a processor, or the like, or a combination thereof. These may be configured by a single chip or may be configured by a plurality of chips connected via a bus. Some or all of the components of each device may be implemented by a combination of the above-described circuit or the like and a program.

In addition, in a case where some or all of the components of the planning unit 20 are implemented by a plurality of information processing devices, circuits, and the like, the plurality of information processing devices, circuits, and the like may be disposed in a centralized manner or in a distributed manner. For example, the information processing device, the circuit, and the like may be implemented as a mode in which the same are connected to each other via a communication network such as a client server system and a cloud computing system.

The plan evaluation function storage unit 26 and the utility function storage unit 28 are implemented by, for example, a magnetic disk or the like.

The negotiation unit 40 negotiates with another agent based on the utility calculated by the planning unit 20. Specifically, in a case where a request for a target resource is received from another agent, the negotiation unit 40 notifies the planning unit 20 of the request from another agent, and receives the calculated utility from the planning unit 20. Then, in a case where the calculated utility exceeds a predetermined threshold value, the negotiation unit 40 may determine to permit the request for the target resource from another agent.

Furthermore, in a case where the own agent proposes use of the target resource to another agent, the negotiation unit 40 notifies the planning unit 20 of a request for proposal, and receives the calculated utility from the planning unit 20. It is noted that the proposed request is input to the negotiation unit 40 by, for example, an operator or the like. Then, in a case where the calculated utility exceeds a predetermined threshold value, the negotiation unit 40 may determine to propose the use of the target resource to another agent.

It is noted that the protocol used by the negotiation unit 40 for negotiation is freely and selectively determined. The negotiation unit 40 may negotiate with another agent by using, for example, the alternating offers protocol (AOP) described in NPL 1.

In addition, the negotiation target to be another agent may be a computer (information processing device) that performs automatic negotiation or a device that performs manual determination. A device (personal computer or the like) that performs manual determination is implemented by, for example, a device (keyboard or the like) capable of responding (accepting or rejecting) to a proposal (acceptance or rejection) transmitted from the negotiation unit 40 or inputting a value used for a counter offer.

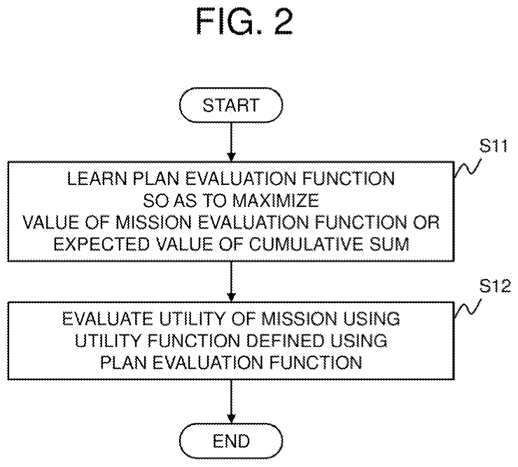

Next, an operation of the negotiation system of the present exemplary embodiment will be described. FIG. 2 is a flowchart illustrating an operation example of the planning unit 20 according to the present exemplary embodiment. The learning unit 24 learns a plan evaluation function so as to maximize a value of a mission evaluation function or an expected value of the cumulative sum of the values (step S11). Then, the evaluation unit 30 evaluates a utility of a mission using a utility function defined using the plan evaluation function (step S12).

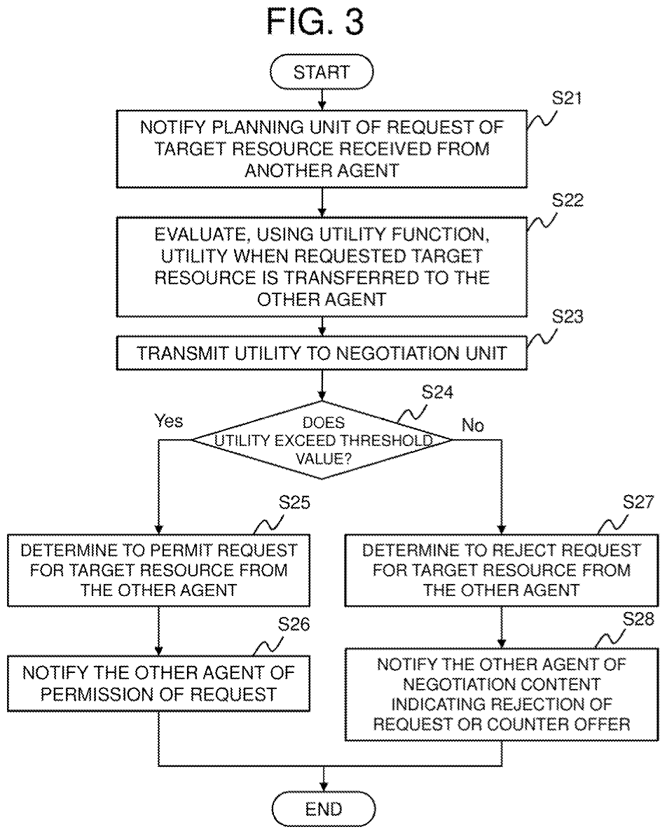

Next, a description will be given as to an operation example in a case where the negotiation system 100 receives a request for a target resource from another agent. FIG. 3 is a flowchart illustrating an operation example of the negotiation system 100 of the present exemplary embodiment.

First, the negotiation unit 40 notifies the planning unit 20 of a request for a target resource received from another agent (step S21). The evaluation unit 30 of the planning unit 20 evaluates, using the utility function, a utility in a case where the requested target resource is transferred to the other agent (step S22). Then, the evaluation unit 30 transmits the calculated utility to the negotiation unit 40 (step S23).

When the calculated utility exceeds a predetermined threshold value (Yes in step S24), the negotiation unit 40 determines to permit the request for the target resource from the other agent (step S25), and notifies the other agent of information indicating the permission of the request (step S26). On the other hand, when the calculated utility is equal to or less than the threshold value (No in step S24), the negotiation unit 40 determines to reject the request for the target resource from the other agent (step S27), and notifies the other agent of a negotiation content indicating the rejection of the request or a counter offer (step S28).

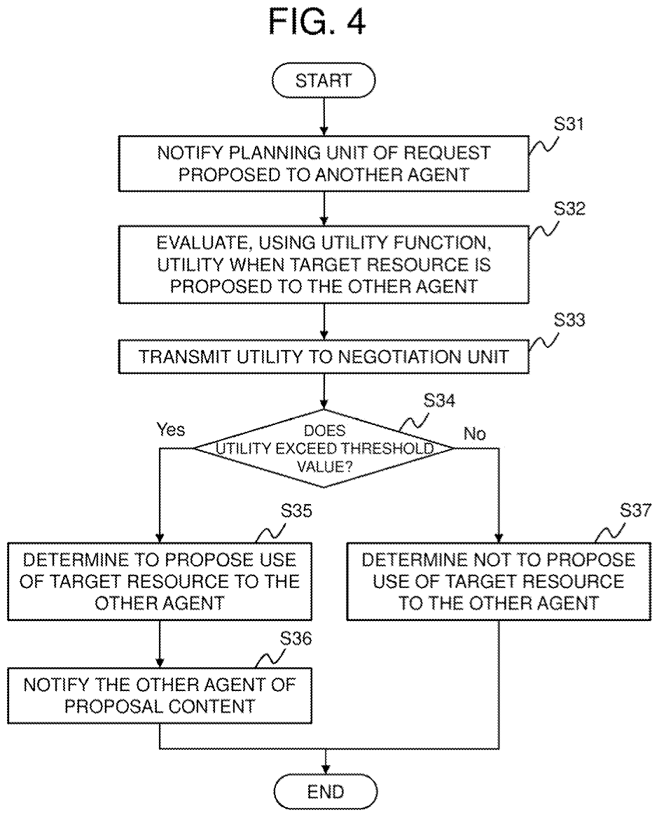

Next, a description will be given as to an operation example in a case where the own agent proposes the use of a target resource to another agent. FIG. 4 is a flowchart illustrating another operation example of the negotiation system 100 of the present exemplary embodiment.

First, the negotiation unit 40 notifies the planning unit 20 of a request to make a proposal to another agent (step S31). The evaluation unit 30 of the planning unit 20 evaluates, using the utility function, a utility in a case where a target resource is proposed to the other agent (step S32). Then, the evaluation unit 30 transmits the calculated utility to the negotiation unit 40 (step S33).

When the calculated utility exceeds a predetermined threshold value (Yes in step S34), the negotiation unit 40 determines to propose the use of the target resource to the other agent (step S35), and notifies the other agent of a proposal content (step S36). On the other hand, when the calculated utility is equal to or less than the threshold value (No in step S34), the negotiation unit determines not to propose the use of the target resource to the other agent (step S37).

As described above, in the present exemplary embodiment, the learning unit 24 learns the plan evaluation function so as to maximize a value of the mission evaluation function or an expected value of the cumulative sum of the values, and the evaluation unit 30 evaluates, using the utility function that defines a difference between the internal values calculated using the plan evaluation function, a utility of a mission in a case where a target resource is transferred to another agent or in a case where the target resource is transferred from another agent. Therefore, even in a case where there is an interaction with another agent regarding a mission to be planned, the utility for the own agent can be appropriately evaluated.

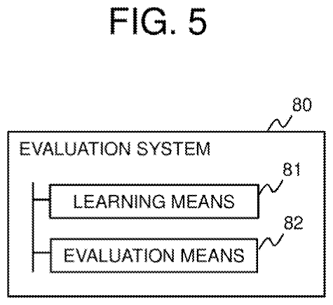

Next, an outline of the present invention will be described. FIG. 5 is a block diagram illustrating an outline of an evaluation system according to the present invention. An evaluation system 80 (for example, the planning unit 20) according to the present invention includes: a learning means 81 (for example, the learning unit 24) configured to learn a plan evaluation function that evaluates an internal value in an own agent when a mission including an action is planned so as to maximize a value of a mission evaluation function that calculates a value of the action (for example, a) of the own agent (for the mission) in a certain state (for example, s) or an expected value of a cumulative sum (for example, G in Equation 4 shown above) of the values; and an evaluation means 82 (for example, the evaluation unit 30) configured to evaluate, using a utility function (for example, Equation 6 shown above) that defines a difference in the internal values calculated using the plan evaluation function, a utility of the mission in a case where a target resource (for example, ω), which is a resource to be a target candidate for negotiation, is transferred to another agent or in a case where the target resource is transferred from another agent.

With such a configuration, even in a case where there is an interaction with another agent regarding a mission to be planned, the utility for the own agent can be appropriately evaluated.

In addition, the learning means 81 may learn a policy function (for example, π(a|s)) and a state value function (for example, V(s)) using the mission evaluation function as a reward function, and the evaluation means 82 may evaluate the utility using the utility function having the state value function as the plan evaluation function.

In addition, the learning means 81 may learn a state action value function (for example, Q(s, a)) using the mission evaluation function as a reward function, and generate a policy function and a state value function using the learned state action value function, and the evaluation means 82 may evaluate the utility using the utility function using the generated state value function as the plan evaluation function.

In addition, the evaluation means 82 may calculate, using the plan evaluation function, the internal value of the mission when the target resource requested from the other agent is not used, and evaluate, using the utility function, the utility when the target resource is transferred to the other agent.

In addition, the evaluation means 82 may calculate, using the plan evaluation function, the internal value of the mission when the target resource requested by the own agent is used, and evaluate, using the utility function, the utility when the target resource is transferred from the other agent.

In addition, a state evaluated by the plan evaluation function may include position information of a moving body, and the target resource serving as an argument of the utility may include the position information of the moving body at a certain time.

Furthermore, the state evaluated by the plan evaluation function may include information (for example, weather, costs of mission, and the like) that does not directly depend on the negotiation.

Furthermore, the mission evaluation function may include a consideration for the action as a term used for calculation of the value.

Furthermore, the learning means 81 may learn the plan evaluation function using at least one of a state transition model, a simulator, and a predetermined function.

In addition, the utility function may be defined by a function (for example, Equation 6 shown above) in which the consideration is added to a difference between the internal value adjusted by the negotiation and an original internal value.

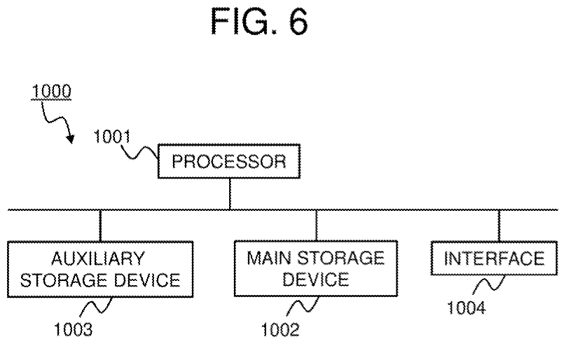

FIG. 6 is a schematic block diagram illustrating a configuration of a computer according to at least one exemplary embodiment. A computer 1000 includes a processor 1001, a main storage device 1002, an auxiliary storage device 1003, and an interface 1004.

The above-described evaluation system 80 is implemented in the computer 1000. Then, the operation of each processing unit described above is stored in the auxiliary storage device 1003 in the form of a program (evaluation program). The processor 1001 reads the program from the auxiliary storage device 1003, loads the program in the main storage device 1002, and executes the above-described processing according to the program.

It is noted that, in at least one exemplary embodiment, the auxiliary storage device 1003 is an example of a non-transitory tangible medium. Other examples of the non-transitory tangible medium include a magnetic disk, a magneto-optical disk, a compact disc read-only memory (CD-ROM), a DVD read-only memory (DVD-ROM), a semiconductor memory, and the like connected via the interface 1004. Furthermore, in a case where this program is distributed to the computer 1000 via a communication line, the computer 1000 that has received the distribution may load the program in the main storage device 1002 and execute the above-described processing.

Furthermore, the program may be provided to implement a part of the functions described above. Furthermore, the program may be a program that implements the above-described functions in combination with another program already stored in the auxiliary storage device 1003, that is, a so-called difference file (difference program).

Some or all of the exemplary embodiments may be described as the following supplementary notes, but are not limited to the following descriptions.

(Supplementary Note 1) An evaluation system including:
a learning means configured to learn a plan evaluation function that evaluates an internal value in an own agent when a mission including an action is planned so as to maximize a value of a mission evaluation function that calculates a value of the action of the own agent in a certain state or an expected value of a cumulative sum of the values; and
an evaluation means configured to evaluate, using a utility function that defines a difference between the internal values calculated using the plan evaluation function, a utility of the mission when a target resource, which is a resource to be a target candidate for negotiation, is transferred to another agent or when the target resource is transferred from the other agent.

(Supplementary Note 2) The evaluation system according to supplementary note 1, in which:
the learning means learns, using the mission evaluation function as a reward function, a policy function and a state value function; and
the evaluation means evaluates the utility using the utility function having the state value function as the plan evaluation function.

(Supplementary Note 3) The evaluation system according to supplementary note 1, in which:
the learning means learns, using the mission evaluation function as a reward function, a state action value function, and generates, using the learned state action value function, a policy function and a state value function; and
the evaluation means evaluates the utility using the utility function having the generated state value function as the plan evaluation function.

(Supplementary Note 4) The evaluation system according to any one of supplementary notes 1 to 3, in which the evaluation means calculates, using the plan evaluation function, the internal value of the mission when the target resource requested from the other agent is not used, and evaluates, using the utility function, the utility when the target resource is transferred to the other agent.

(Supplementary Note 5) The evaluation system according to any one of supplementary notes 1 to 4, in which the evaluation means calculates, using the plan evaluation function, the internal value of the mission when the target resource requested by the own agent is used, and evaluates, using the utility function, the utility when the target resource is transferred from the other agent.

(Supplementary Note 6) The evaluation system according to any one of supplementary notes 1 to 5, in which:
a state evaluated by the plan evaluation function includes position information of a moving body; and
the target resource serving as an argument of the utility includes the position information of the moving body at a certain time.

(Supplementary Note 7) The evaluation system according to any one of supplementary notes 1 to 6, in which a state evaluated by the plan evaluation function includes information that does not directly depend on the negotiation.

(Supplementary Note 8) The evaluation system according to any one of supplementary notes 1 to 7, in which the mission evaluation function includes a consideration for the action as a term used for calculation of the value.

(Supplementary Note 9) The evaluation system according to any one of supplementary notes 1 to 8, in which the learning means learns the plan evaluation function using at least one of a state transition model, a simulator, and a predetermined function.

(Supplementary Note 10) The evaluation system according to any one of supplementary notes 1 to 9, in which the utility function is defined by a function obtained by adding a consideration to a difference between the internal value adjusted by the negotiation and an original internal value.

(Supplementary Note 11) An evaluation method including:
learning, by a computer, a plan evaluation function that evaluates an internal value in an own agent when a mission including an action is planned so as to maximize a value of a mission evaluation function that calculates a value of the action of the own agent in a certain state or an expected value of a cumulative sum of the values; and
evaluating, by the computer using a utility function that defines a difference between the internal values calculated using the plan evaluation function, a utility of the mission when a target resource, which is a resource to be a target candidate for negotiation, is transferred to another agent or when the target resource is transferred from the other agent.

(Supplementary Note 12) The evaluation method according to supplementary note 11, further including:
learning, using the mission evaluation function as a reward function, a policy function and a state value function; and
evaluating the utility using the utility function having the state value function as the plan evaluation function.

(Supplementary Note 13) The evaluation method according to supplementary note 11, further including:
learning, using the mission evaluation function as a reward function, a state action value function, and generating, using the learned state action value function, a policy function and a state value function, and
evaluating the utility using the utility function having the generated state value function as the plan evaluation function.

(Supplementary Note 14) A program storage medium having an evaluation program stored therein and configured to cause a computer to execute:
a learning process of learning a plan evaluation function that evaluates an internal value in an own agent when a mission including an action is planned so as to maximize a value of a mission evaluation function that calculates a value of the action of the own agent in a certain state or an expected value of a cumulative sum of the values; and
an evaluation process of evaluating, using a utility function that defines a difference between the internal values calculated using the plan evaluation function, a utility of the mission when a target resource, which is a resource to be a target candidate for negotiation, is transferred to another agent or when the target resource is transferred from the other agent.

(Supplementary Note 15) The program storage medium according to supplementary note 14, having the evaluation program stored therein and configured to cause the computer to:
learn, by the learning process, a policy function and a state value function using the mission evaluation function as a reward function; and
evaluate, by the evaluation process, the utility using the utility function having the state value function as the plan evaluation function.

(Supplementary Note 16) The program storage medium according to supplementary note 14, having the evaluation program stored therein and configured to:
learn, by the learning process, a state action value function using the mission evaluation function as a reward function, and generate a policy function and a state value function using the learned state action value function; and
evaluate, by the evaluation process, the utility using the utility function having the generated state value function as the plan evaluation function.

(Supplementary Note 17) An evaluation program configured to cause a computer to execute:
a learning process of learning a plan evaluation function that evaluates an internal value in an own agent when a mission including an action is planned so as to maximize a value of a mission evaluation function that calculates a value of the action of the own agent in a certain state or an expected value of a cumulative sum of the values; and
an evaluation process of evaluating, using a utility function that defines a difference between the internal values calculated using the plan evaluation function, a utility of the mission when a target resource, which is a resource to be a target candidate for negotiation, is transferred to another agent or when the target resource is transferred from the other agent.

(Supplementary Note 18) The evaluation program according to supplementary note 17, configured to cause the computer to:
learn, by the learning process, a policy function and a state value function using the mission evaluation function as a reward function; and
evaluate, by the evaluation process, the utility using the utility function having the state value function as the plan evaluation function.

(Supplementary Note 19) The evaluation program according to supplementary note 17, configured to:
learn, by the learning process, a state action value function using the mission evaluation function as a reward function, and generate a policy function and a state value function using the learned state action value function; and
evaluate, by the evaluation process, the utility using the utility function having the generated state value function as the plan evaluation function.

Although the present invention has been described above with reference to the exemplary embodiments, the present invention is not limited to the above-described exemplary embodiments. Various modifications that can be understood by those skilled in the art can be made to the configuration and details of the present invention within the scope of the present invention.

### REFERENCE SIGNS LIST

10 Mission evaluation unit
20 Planning unit
22 Input unit
24 Learning unit
26 Plan evaluation function storage unit
28 Utility function storage unit
30 Evaluation unit
40 Negotiation unit
100 Negotiation system

What is claimed is:

1. An evaluation system comprising:
a memory storing instructions; and
one or more processors configured to execute the instructions to:
learn a plan evaluation function that evaluates an internal value in an own agent when a mission including an action is planned so as to maximize a value of a mission evaluation function that calculates a value of the action of the own agent in a certain state or an expected value of a cumulative sum of the values; and
evaluate, using a utility function that defines a difference between the internal values calculated using the plan evaluation function, a utility of the mission when a target resource, which is a resource to be a target candidate for negotiation, is transferred to another agent or when the target resource is transferred from the other agent.

2. The evaluation system according to claim 1, wherein the processor is configured to execute the instructions to:
learn, using the mission evaluation function as a reward function, a policy function and a state value function; and
evaluate the utility using the utility function having the state value function as the plan evaluation function.

3. The evaluation system according to claim 1, wherein the processor is configured to execute the instructions to:
learn, using the mission evaluation function as a reward function, a state action value function, and generate, using the learned state action value function, a policy function and a state value function; and
evaluate the utility using the utility function having the generated state value function as the plan evaluation function.

4. The evaluation system according to claim 1,
wherein the processor is configured to execute the instructions to calculate, using the plan evaluation function, the internal value of the mission when the target resource requested from the other agent is not used, and evaluate, using the utility function, the utility when the target resource is transferred to the other agent.

5. The evaluation system according to claim 1,
wherein the processor is configured to execute the instructions to calculate, using the plan evaluation function, the internal value of the mission when the target resource requested by the own agent is used, and evaluate, using the utility function, the utility when the target resource is transferred from the other agent.

6. The evaluation system according to claim 1,
wherein a state evaluated by the plan evaluation function includes position information of a moving body, and
wherein the target resource serving as an argument of the utility includes the position information of the moving body at a certain time.

7. The evaluation system according to claim 1,
wherein a state evaluated by the plan evaluation function includes information that does not directly depend on the negotiation.

8. The evaluation system according to claim 1,
wherein the mission evaluation function includes a consideration for the action as a term used for calculation of the value.

9. The evaluation system according to claim 1, wherein the processor is configured to execute the instructions to learn the plan evaluation function using at least one of a state transition model, a simulator, and a predetermined function.

10. The evaluation system according to claim 1,
wherein the utility function is defined by a function obtained by adding a consideration to a difference between the internal value adjusted by the negotiation and an original internal value.

11. An evaluation method comprising:
learning, by a computer, a plan evaluation function that evaluates an internal value in an own agent when a mission including an action is planned so as to maximize a value of a mission evaluation function that calculates a value of the action of the own agent in a certain state or an expected value of a cumulative sum of the values; and
evaluating, by the computer using a utility function that defines a difference between the internal values calculated using the plan evaluation function, a utility of the mission when a target resource, which is a resource to be a target candidate for negotiation, is transferred to another agent or when the target resource is transferred from the other agent.

12. The evaluation method according to claim 11, further comprising:
learning, using the mission evaluation function as a reward function, a policy function and a state value function; and
evaluating the utility using the utility function having the state value function as the plan evaluation function.

13. The evaluation method according to claim 11, further comprising:
learning, using the mission evaluation function as a reward function, a state action value function, and generating, using the learned state action value function, a policy function and a state value function; and
evaluating the utility using the utility function having the generated state value function as the plan evaluation function.

14. A non-transitory computer readable information recording medium storing an evaluation program, when executed by a processor, that performs a method for:
learning a plan evaluation function that evaluates an internal value in an own agent when a mission including an action is planned so as to maximize a value of a mission evaluation function that calculates a value of the action of the own agent in a certain state or an expected value of a cumulative sum of the values; and
evaluating, using a utility function that defines a difference between the internal values calculated using the plan evaluation function, a utility of the mission when a target resource, which is a resource to be a target candidate for negotiation, is transferred to another agent or when the target resource is transferred from the other agent.

15. The non-transitory computer readable information recording medium according to claim 14, wherein
a policy function and a state value function are learned using the mission evaluation function as a reward function, and
the utility is evaluated using the utility function having the state value function as the plan evaluation function.

16. The non-transitory computer readable information recording medium according to claim 14,
a state action value function is learned using the mission evaluation function as a reward function, and a policy function and a state value function are generated using the learned state action value function, and
the utility is evaluated using the utility function having the generated state value function as the plan evaluation function.
